(19) United States
(12) Patent Application Publication
(10) Pub. No.: US 2017/0137320 A1
(43) Pub. Date: May 18, 2017

(54) METHOD FOR OBTAINING A MATERIAL COMPRISING A FUNCTIONAL LAYER MADE FROM SILVER RESISTANT TO A HIGH-TEMPERATURE TREATMENT

(71) Applicant: SAINT-GOBAIN GLASS FRANCE, Courbevoie (FR)

(72) Inventor: Sophie BROSSARD, Minneapolis, MN (US)

(21) Appl. No.: 15/313,742

(22) PCT Filed: May 27, 2015
(86) PCT No.: PCT/FR2015/051404

§ 371 Date: Nov. 23, 2016

(30) Foreign Application Priority Data
May 28, 2014 (FR) 1454870

(51) Int. Cl. C03C 17/36

(52) U.S. Cl. CPC C03C 17/366; C03C 17/3618; C03C 17/3644; C03C 17/3626; C03C 2217/734; C03C 2218/31; C03C 2217/212; C03C 2217/256; C03C 2218/154; C03C 2217/216; C03C 2217/281

(57) ABSTRACT

A process for obtaining a material including a transparent substrate coated with a stack of thin layers including at least one silver-based functional metal layer located above at least one antireflective coating, the transparent substrate coated with the stack to be subjected to a heat treatment at a temperature Tmax of greater than 400° C., the antireflective coating including at least one dielectric layer configured to generate defects of hole type, the process including depositing the antireflective coating including at least one dielectric layer liable to generate defects of hole type on the transparent substrate, then subjecting the dielectric layer configured to generate defects of hole type to a heat pretreatment, then depositing the at least one silver-based functional metal layer.

The invention relates to a process for obtaining a material, such as a glazing, comprising a transparent substrate coated with a stack of thin layers comprising at least one silver-based functional metal layer. The material is intended to be subjected to a high-temperature heat treatment.

Silver-based functional metal layers (or silver layers) have advantageous properties of electrical conduction and of reflection of infrared (IR) rays, hence their use in “solar control” glazings, targeted at reducing the amounts of incoming solar energy, and/or in “low-e” glazings, targeted at reducing the amount of energy dissipated towards the outside of a building or vehicle.

These silver layers are deposited between antireflective coatings, which generally comprise several dielectric layers making it possible to adjust the optical properties of the stack. In addition, these dielectric layers make it possible to protect the silver layer from chemical or mechanical attacks.

The optical and the electrical properties of the material depend directly on the quality of the silver layers, such as their crystal state, their homogeneity and also their environment, such as the nature of the layers located above and below the silver layer.

The invention relates very particularly to a material subjected to a high-temperature heat treatment, such as an annealing, a bending and/or a tempering. The high-temperature heat treatments can bring about modifications within the silver layer and in particular generate defects. Some of these defects exist in the hole form.

The defects of “hole” type correspond to the appearance of regions devoid of silver exhibiting a circular or dendritic form, that is to say to a partial dewetting of the silver layer.

The presence of defects generates light scattering phenomena which are reflected visually by the appearance of a luminous halo known as “haze”, generally visible under intense light. The haze corresponds to the amount of the transmitted light which is scattered at angles of more than 2.5°.

The presence of these defects also appears to generate a decrease in the conductivity and in the mechanical strength and a greater sensitivity to the appearance of points of corrosion. These points of corrosion are often visible even in normal light.

The reasons and mechanisms for the formation of these defects are still poorly understood. The occurrence of defects of hole type appears to be strongly dependent on the nature of the dielectric layers making up the antireflective coatings located above and below the silver layer. The presence of certain dielectric materials in the stack, in particular certain oxides, increases the formation of certain defects.

The objective of the invention is to develop a process for obtaining a material comprising a substrate coated with a stack which can undergo high-temperature heat treatments of bending, tempering and/or annealing type while retaining good optical, mechanical and corrosion resistance properties.

The applicant has discovered that the presence of a layer based on titanium oxide (TiO₂), on niobium oxide (Nb₂O₅) or on tin oxide (SnO₂) in antireflective coatings, in particular located below the silver layer, promotes the formation of defects of hole type in the silver layer during a high-temperature heat treatment. In point of fact, these materials are optically advantageous materials because of their high refractive index.

The applicant has discovered that carrying out a heat pretreatment on the layers liable to generate defects of hole type, before deposition of the silver layer, makes it possible to prevent these holes from appearing during the heat treatment of the complete stack.

The invention relates to a process for obtaining a material comprising a transparent substrate coated with a stack of thin layers comprising at least one silver-based functional metal layer located above at least one antireflective coating,

the transparent substrate coated with the stack is intended to be subjected to a heat treatment at a temperature Tmax of greater than 400° C.,
the antireflective coating comprises at least one dielectric layer liable to generate defects of hole type,
the process comprises the sequence of following stages:
the antireflective coating comprising at least one dielectric layer liable to generate defects of hole type is deposited on the transparent substrate, then
the dielectric layer liable to generate defects of hole type is subjected to a heat pretreatment, then
said at least one silver-based functional metal layer is deposited.

The process of the invention makes it possible to obtain the advantageous properties despite the presence, in the stack, of thin layers liable to generate defects of hole type.

The maximum temperature Tmax corresponds to the highest temperature achieved during the heat treatment to which the transparent substrate coated with the stack is subjected.

The pretreatment of the layer liable to generate defects of hole type makes it possible to significantly prevent the dewetting and the appearance of defects of dendritic hole type in the silver layer when the substrate coated with the stack is subjected to a heat treatment.

The stack is deposited by cathode sputtering, in particular assisted by a magnetic field (magnetron process). Each layer of the stack can be deposited by cathode sputtering.

Unless otherwise mentioned, the thicknesses mentioned in the present document are physical thicknesses. Thin layer is understood to mean a layer exhibiting a thickness of between 0.1 nm and 100 micrometers.

Throughout the description, the substrate according to the invention is regarded as positioned horizontally. The stack of thin layers is deposited above the substrate. The meaning of the expressions “above” and “below” and “lower” and “upper” is to be considered with respect to this orientation. Unless specifically stipulated, the expressions “above” and “below” do not necessarily mean that two layers and/or coatings are positioned in contact with one another. When it is specified that a layer is deposited “in contact” with another layer or with a coating, this means that there cannot be one or more layers inserted between these two layers.

The dielectric layers liable to generate defects of hole type are chosen from layers based on titanium oxide (TiO₂), on niobium oxide (Nb₂O₅) and on tin oxide (SnO₂).

The dielectric layers liable to generate defects of hole type are deposited by cathode sputtering.

The dielectric layers liable to generate defects of hole type have a thickness of greater than 5 nm, preferably of between 8 and 20 nm.

The solution provided according to the invention is suitable when the thin layer liable to generate defects of hole type is sufficiently close to the silver-based functional layer to induce defects. This is because, in the case of a complex stack comprising antireflective coatings with a certain number of dielectric layers, when the layer liable to generate defects of hole type is separated from the silver-based functional layer by a great thickness of one or more layers not liable to generate defects or liable to generate defects of dome type, the ability to generate defects of hole type is reduced, indeed even annulled.

The thin layer liable to generate defects of hole type of the antireflective coating is separated from the functional layer by one or more layers; the thickness of all the layers inserted between the layer liable to generate defects of hole type and the functional layer is at most 20 nm, preferably at most 15 nm.

The heat pretreatment of the thin layer liable to generate defects of hole type before deposition of the silver-based functional metal layer can be carried out by any heating process. The pretreatment can be carried out by placing the substrate in a furnace or an oven or by subjecting the substrate to radiation.

The heat pretreatment is advantageously carried out by subjecting the substrate coated with the layer to be treated to radiation, preferably laser radiation focused on said layer in the form of at least one laser line.

The heat pretreatment can be carried out by contributing energy capable of bringing each point of the thin layer liable to generate defects of hole type to a temperature preferably of at least 300° C., in particular 350° C., indeed even 400° C., and even 500° C. or 600° C. Each point of the coating is subjected to the heat pretreatment for a period of time of less than or equal to 1 second, indeed even 0.5 second and advantageously within a range extending from 0.05 to 10 ms, in particular from 0.1 to 5 ms or from 0.1 to 2 ms.

The wavelength of the radiation is preferably within a range extending from 500 to 2000 nm, in particular from 700 to 1100 nm, indeed even from 800 to 1000 nm. High-power laser diodes which emit at one or more wavelengths chosen from 808 nm, 880 nm, 915 nm, 940 nm or 980 nm have proved to be particularly well suited.

The heat pretreatment can also be carried out by subjecting the substrate to infrared radiation resulting from conventional heating devices, such as infrared lamps.

The thin layers liable to generate defects of hole type can be deposited from metal or ceramic targets comprising the elements intended to form said layers. These layers can be deposited in an oxidizing atmosphere or a non-oxidizing atmosphere (that is to say, without deliberate introduction of oxygen), preferably an oxidizing atmosphere preferably consisting of noble gas(es) (He, Ne, Xe, Ar or Kr).

When the thin layer liable to generate defects of hole type is a layer based on titanium oxide, this layer can be completely oxidized in the TiO₂ form or partially suboxidized. This layer can also optionally be doped, for example with zirconium. When it is partially suboxidized, it is thus not deposited in the stoichiometric form but in the substoichiometric form, of the TiOₓ type, where x is a number different from the stoichiometry of titanium oxide TiO₂, that is to say different from 2 and preferably less than 2, in particular between 0.75 times and 0.99 times the normal stoichiometry of the oxide. TiOₓ can in particular be such that 1.5<x<1.98 or 1.5<x<1.7, indeed even 1.7<x<1.95.

The layer of titanium oxide can be deposited from a ceramic target or from a titanium metal target.

The layer of niobium oxide can be deposited from an Nb₂O₅ ceramic target or from a niobium metal target.

The layer of tin oxide can be deposited from an SnO₂ ceramic target or from a tin metal target.

The thickness of the silver-based functional layers is, by order of increasing preference, of from 5 to 20 nm, from 8 to 15 nm.

The silver-based functional metal layers can be in contact with a blocking layer. A blocking underlayer corresponds to a blocking layer positioned under a functional layer, which position is defined with respect to the substrate. A blocking layer positioned over the functional layer on the opposite side from the substrate is known as blocking overlayer.

The blocking layers are chosen from the layers based on NiCr, NiCrN, NiCrOₓ, NiO or NbN. The thickness of each blocking layer is at least 0.5 nm and at most 4.0 nm.

The stack comprises at least two antireflective coatings, each antireflective coating comprising at least one dielectric layer, so that each functional metal layer is positioned between two antireflective coatings. The process additionally comprises the stage according to which the antireflective coating is deposited above the silver-based functional metal layer.

The antireflective coatings can comprise dielectric layers having a barrier function and/or dielectric layers having a stabilizing function.

The dielectric layers of the antireflective coatings can be chosen from the oxides or nitrides of one or more elements chosen from titanium, silicon, aluminum, tin and zinc.

The dielectric layers of the antireflective coating or coatings are preferably deposited by cathode sputtering assisted by a magnetic field.

Dielectric layers having a stabilizing function is understood to mean a layer made of a material capable of stabilizing the interface between the functional layer and this layer. The dielectric layers having a stabilizing function are preferably based on crystalline oxide, in particular based on zinc oxide, optionally doped using at least one other element, such as aluminum. The dielectric layer or layers having a stabilizing function are preferably layers of zinc oxide. This is because it is advantageous to have a layer having a stabilizing function, for example based on zinc oxide, below a functional layer as it facilitates the adhesion and the crystallization of the silver-based functional layer and enhances its quality and its high-temperature stability. It is also advantageous to have a layer having a stabilizing function, for example based on zinc oxide, above a functional layer.

The dielectric layer or layers having a stabilizing function can thus be found above and/or below at least one silver-based functional metal layer or each silver-based functional metal layer, either directly in contact with it or separated by a blocking layer. Preferably, each silver-based functional metal layer is above an antireflective coating, the upper layer of which is a dielectric layer having a stabilizing function, preferably based on zinc oxide, and/or below an antireflective coating, the low layer of which is a dielectric layer having a stabilizing function, preferably based on zinc oxide.

This dielectric layer having a stabilizing function can have a thickness of at least 5 nm, in particular a thickness of between 5 and 25 nm and better still from 8 to 15 nm.

The thin layer liable to generate defects of hole type of the antireflective coating is thus generally separated from the functional layer by the stabilizing layer of the antireflective coating and optionally by a blocking layer.

The thin layer liable to generate defects of hole type of the antireflective coating is separated from the functional layer by one or more layers; the thickness of all the layers inserted between the layer liable to generate defects of hole type and the functional layer is at least 6 nm, preferably at least 7.5 nm.

Dielectric layers having a barrier function is understood to mean a layer made of a material capable of forming a barrier to the diffusion of oxygen, alkalines and/or water at high temperature, originating from the ambient atmosphere or from the transparent substrate, toward the functional layer. The dielectric layers having a barrier function can be based on silicon compounds chosen from oxides, such as SiO₂, silicon nitrides Si₃N₄ and oxynitrides SiOₓN_{y}, optionally doped with at least one other element, such as aluminum, based on aluminum nitrides AlN or based on zinc tin oxide.

The transparent substrate coated with the stack intended to be subjected to a heat treatment can comprise:
an antireflective coating comprising at least one thin layer liable to generate defects of hole type,
optionally a blocking layer,
a silver-based functional metal layer,
an antireflective coating.

According to an advantageous embodiment, the stack can comprise:
an antireflective coating located below the silver-based functional metal layer comprising at least one thin layer liable to generate defects of hole type and a dielectric layer having a stabilizing function based on zinc oxide separating the layer exhibiting a stress jump from the silver-based functional metal layer,
optionally a blocking layer, located immediately in contact with the dielectric layer having a stabilizing function based on zinc oxide,
a silver-based functional metal layer located immediately in contact with the blocking layer,
optionally a blocking overlayer,
an antireflective coating located above the silver-based functional metal layer,
optionally an upper protective layer.

According to another advantageous embodiment, the stack can comprise, starting from the substrate:
an antireflective coating comprising at least one dielectric layer having a barrier function and at least one dielectric layer having a stabilizing function,
optionally a blocking layer,
a functional layer,
an antireflective coating comprising at least one dielectric layer having a stabilizing function and a dielectric layer having a barrier function.

The stack can comprise an upper protective layer deposited as final layer of the stack, in particular in order to confer scratch-resistant properties. These upper protective layers preferably have a thickness of between 2 and 5 nm.

The substrate can be made of any material capable of withstanding the high temperatures of the heat treatment. The transparent substrates according to the invention are preferably made of a rigid inorganic material, such as made of glass, in particular soda-lime-silica glass. The thickness of the substrate generally varies between 0.5 mm and 19 mm. The thickness of the substrate is preferably less than or equal to 6 mm, indeed even 4 mm.

The applicant has discovered that, among the layers based on oxide which are liable to generate holes during the heat treatment, some oxides, deposited as a thin layer on a substrate, exhibit a stress jump. A stress jump corresponds to a significant change in the slope of the curve connecting the change in the stress as a function of the temperature.

Processes for measuring the stress as a function of the temperature are known. The paper entitled “Effect of postdeposition annealing on the structure, composition, and the mechanical and optical characteristics of niobium and tantalum oxide films”, Applied Optics, Vol. 51, Issue 27, pp. 6498-6507, by Eda çetinörgü-Goldenberg, Jolanta-Ewa Klemberg-Sapieha and Ludvik Martinu, describes in particular the curves of change in the stress as a function of the temperature for niobium oxide. Results similar to those obtained for niobium oxide have been obtained with titanium oxide. Specifically, a layer based on titanium oxide or a layer based on niobium oxide can exhibit a variation of greater than 0.1 GPa for a variation in temperature of less than 75° C.

The stress jump can be related to a crystallization of the material constituting the layer during the heat treatment. This is because, after cooling, the stress values of the material are higher than those before heat treatment. Once the stress jump has been carried out, the thin layer can be heated and cooled without a stress jump again being produced.

The stress jump is generally produced within a temperature range lower than the temperature Tmax of the heat treatment.

Carrying out a heat pretreatment of the layers exhibiting a stress jump, before deposition of the silver layer, makes it possible to prevent this stress jump from taking place during the heat treatment of the complete stack. In this case, the silver layer does not undergo deformations due to its proximity to the layer exhibiting a stress jump.

The dielectric layer liable to generate defects of hole type is chosen from a dielectric layer exhibiting a stress jump taking place within a temperature range lower than the temperature Tmax of the heat treatment and corresponding to a variation in the stress values of greater than 0.1 GPa for a variation in temperature of less than 50° C. The heat pretreatment 5 is carried out by contributing energy capable of bringing each point of said layer to a temperature greater than or equal to a temperature located in the temperature range in which the stress jump takes place.

The heat pretreatment is advantageously carried out so that each point of the layer is brought to a temperature of at least 300° C. while keeping, at any point, the face of the substrate opposite that comprising the stack at a temperature of less than or equal to 150° C.

“Point of the layer” is understood to mean a region of the layer undergoing the treatment at a given instant. According to the invention, the whole of the layer (thus each point) is brought to a temperature of at least 300° C., but each point of the layer is not necessarily treated simultaneously. The layer can be treated at the same instant in its entirety, each point of the layer being simultaneously brought to a temperature of at least 300° C. The layer can alternatively be treated so that the different points of the layer or of the assemblies of points are successively brought to a temperature of at least 300° C., this second mode being most often employed in the case of a continuous implementation on the industrial scale.

These heat pretreatments exhibit the advantage of heating only the layer, without significant heating of the whole of the substrate, moderate and controlled heating of a limited region of the substrate, and thus of preventing breakage problems. It is thus preferable for the implementation of the present invention for the temperature of the face of the substrate opposite the face carrying the treated layer exhibiting a stress jump not to be greater than 150° C. This characteristic is obtained by choosing a method of heating especially suitable for the heating of the layer and not of the substrate and by controlling the time or the intensity of heating and/or other parameters as a function of the heating method employed. Preferably, each point of the thin layer is subjected to the treatment according to the invention (that is to say, brought to a temperature of greater than or equal to 300° C.) for a period of time generally of less than or equal to 1 second, indeed even 0.5 second.

In order to limit as much as possible the number of breakages for the biggest substrates (for example of 6 m in length by 3 m in width), a temperature of less than or equal to 100° C., in particular 50° C., is preferably maintained throughout the treatment at every point of the face of the substrate opposite the face on which the layer exhibiting a stress jump is deposited.

The parameters of the heating, such as the power of the heating means or the heating time, can be adjusted on a case by case basis by a person skilled in the art as a function of various parameters, such as the nature of the heating process, the thickness of the layer, the size and the thickness of the substrates to be treated, and the like.

The heat pretreatment stage preferably consists in subjecting the substrate coated with the layer to be treated to radiation, preferably laser radiation focused on said layer in the form of at least one laser line. As lasers can only irradiate a small surface area (typically of the order of a fraction of a mm² to a few hundred mm²), it is necessary, in order to treat the entire surface, to provide a system for moving the laser beam in the plane of the substrate or a system forming an inline laser beam simultaneously irradiating the entire width of the substrate and under which the latter will progress forward.

The maximum temperature is normally undergone at the moment when the point of the coating under consideration passes under the laser line. At a given instant, only the points of the surface of the coating located under the laser line and in its immediate surroundings (for example, at less than one millimeter) are normally at a temperature of at least 300° C. For distances to the laser line (measured along the direction of forward progression) of greater than 2 mm, in particular 5 mm, including downstream of the laser line, the temperature of the coating is normally at most 50° C. and even 40° C. or 30° C.

The laser radiation is preferably generated by modules comprising one or more laser sources and also forming and redirecting optics.

The laser sources are typically laser diodes or fiber or disk lasers. Laser diodes make it possible to economically achieve high power densities, with respect to the electrical supply power, for a small space requirement.

The radiation resulting from the laser sources is preferably continuous.

The forming and redirecting optics preferably comprise lenses and mirrors, and are used as means for positioning, homogenizing and focusing the radiation.

The purpose of the positioning means is, if appropriate, to arrange along a line the radiation emitted by the laser sources. They preferably comprise mirrors. The purpose of the homogenizing means is to superimpose the spatial profiles of the laser sources in order to obtain a linear power density which is homogeneous all along the line. The homogenizing means preferably comprise lenses which make possible the separation of the incident beams into secondary beams and the recombination of said secondary beams into a homogenous line. The means for focusing the radiation make it possible to focus the radiation on the coating to be treated, in the form of a line of desired length and desired width. The focusing means preferably comprise a convergent lens.

When just one laser line is used, the length of the line is advantageously equal to the width of the substrate.

The linear power density of the laser line is preferably at least 300 W/cm, advantageously 350 or 400 W/cm, in particular 450 W/cm, indeed even 500 W/cm and even 550 W/cm. It is even advantageously at least 600 W/cm, in particular 800 W/cm, indeed even 1000 W/cm. The linear power density is measured at the spot where the or each laser line is focused on the coating. It can be measured by positioning a power detector along the line, for example a calorimetric power meter, such as, in particular, the BeamFinder S/N 2000716 power meter from Coherent Inc. The power density is advantageously distributed homogeneously along the whole length of the or each line. Preferably, the difference between the highest power density and the lowest power density has a value which is less than 10% of the mean power density.

The energy density provided to the coating is preferably at least 20 J/cm², indeed even 30 J/cm².

The high power densities and energy densities make it possible to heat the coating very rapidly, without significantly heating the substrate.

Preferably, the or each laser line is stationary and the substrate is in motion, with the result that the rates of relative displacement will correspond to the rate of forward progression of the substrate.

The heat pretreatment of the layer liable to generate defects of hole type can be carried out during the deposition in the deposition chamber, or on conclusion of the deposition, outside the deposition chamber. The heat pretreatment can be carried out under vacuum, under air and/or at atmospheric pressure. The heat pretreatment outside the deposition chamber is not preferred as it can cause pollution problems.

The heat treatment device can thus be incorporated in a line for deposition of layers, for example a line for deposition by cathode sputtering assisted by a magnetic field (magnetron process). The line generally comprises devices for handling the substrates, a deposition unit, optical control devices and stacking devices. The substrates progress forward, for example on conveying rollers, successively past each device or each unit.

The heat treatment device can be incorporated in the deposition unit. For example, the laser can be introduced into one of the chambers of a unit for deposition by cathode sputtering, in particular into a chamber where the atmosphere is rarified, in particular under a pressure of between 10⁻⁶ mbar and 10⁻² mbar. The heat treatment device can also be positioned outside the deposition unit but so as to treat a substrate located inside said unit. It is sufficient to provide, for this purpose, a porthole transparent to the wavelength of the radiation used, through which the laser radiation would pass to treat the layer. It is thus possible to treat a layer liable to generate defects of hole type before the subsequent deposition of another layer in the same unit. The heat pretreatment is preferably a laser treatment by radiation in a system where the laser is incorporated in a magnetron device.

Preferably, the heat pretreatment is carried out under vacuum actually within the deposition chamber of the magnetron device.

The heat pretreatment can also be carried out by heating using infrared radiation, a plasma torch or a flame, as described in the application WO 2008/096089.

Systems of infrared lamps in combination with a focusing device (for example, a cylindrical lens), making it possible to achieve high powers per unit of surface area, can also be used.

The coated transparent substrate is intended to be subjected to a heat treatment at a temperature Tmax of greater than 400° C. The heat treatments are chosen from an annealing, for example from a flash annealing, such as a laser or flame annealing, a tempering and/or a bending. The temperature of the heat treatment is greater than 400° C., preferably greater than 450° C. and better still greater than 500° C.

The substrate coated with the stack can be is a bent and/or tempered glass.

The material can be in the form of a monolithic glazing, a laminated glazing, an asymmetric glazing or a multiple glazing, in particular a double glazing or a triple glazing.

### EXAMPLES

Stacks of thin layers defined below are deposited on substrates made of clear soda-lime glass with a thickness of 2 or 4 mm.

For these examples, the conditions for deposition of the layers deposited by sputtering (“magnetron cathode” sputtering) are summarized in table 1 below.

The layers of titanium oxide TiO₂ are deposited from a ceramic target, in an oxidizing atmosphere.

TABLE 1

| | | Deposition | | |
|---|---|---|---|---|
| | | pressure | | Index |
| | Targets employed | (mbar) | Gas | 550 nm |
| Si₃N₄ | Si:Al (92:8% by | 1.5 × 10⁻³ | Ar 47%—N₂ 53% | 2.00 |
| | weight) | | | |
| ZnO | Zn:Al (98:2% by | 1.5 × 10⁻³ | Ar 91%—O₂ 9% | 2.04 |
| | weight) | | | |
| NiCr | NiCr (80:20 at. %): | 8 × 10⁻³ | Ar at 100% | — |
| Ag | Ag | 8 × 10⁻³ | Ar at 100% | — |
| TiO₂ | TiOₓ | 1.5 × 10⁻³ | Ar 88%—O₂ 12% | 2.32 |

at. = atomic

The materials and the physical thicknesses in nanometers (unless otherwise indicated) of each layer or coating which constitutes the stacks of the comparative examples and of the examples according to the invention are listed in the tables below as a function of their position with respect to the substrate carrying the stack.

| Glazing | Layers | D Comp. | D Inv. |
|---|---|---|---|
| Protective layer | TiO₂ | 2 | 2 |
| Antireflective coating | Si₃N₄ | 40 | 40 |
| AR2 | ZnO | 5 | 5 |
| Blocking layer BO | NiCr | 0.5 | 0.5 |
| Functional layer | Ag | 10 | 10 |
| Blocking layer BU | NiCr | — | — |
| Antireflective coating | ZnO | 5 | 5 |
| AR1 | TiO₂ | 30 | 30 |
| Substrate (mm) | Glass | 2 | 2 |
| Heat pretreatment | — | No | Yes |
| FIGS. | — | 3 | 4 |

The process for obtaining these glazings comprising a transparent substrate coated with a stack of thin layers is as follows:
the TiO₂ layer (30 nm) is deposited, then
the layer is optionally subjected to a heat pretreatment, then
the remainder of the stack is deposited, then
the substrate coated with the complete stack is subjected to a heat treatment at a temperature Tmax of greater than 400° C.

The comparative glazing comprises the stack D Comp., that is to say a stack comprising a layer of titanium oxide under the silver layer which has not been subjected to a heat pretreatment before deposition of the silver layer and heat treatment. The glazing of the invention comprises the stack D Inv., that is to say a stack comprising a layer of titanium oxide under the silver layer subjected to a heat pretreatment by a laser annealing at 980 nm before deposition of the silver layer. The heat treatment corresponds to an annealing at 620° C. for 10 minutes.

### I. Microscopic Analysis

The dielectric layers liable to generate defects of hole type can be identified by virtue of a microscopic analysis. For this, a stack comprising a dielectric layer liable to generate defects of hole type on contact with or close to a silver layer is deposited on a substrate. The assembly is subjected to a heat treatment. Observation of the images makes it possible to identify if defects are generated and, if appropriate, if these defects are of hole type.

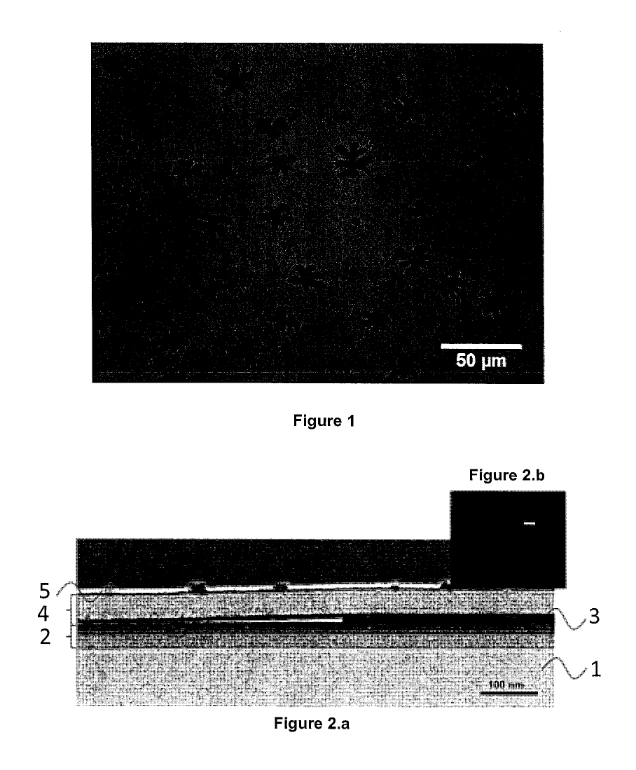

FIGS. 1. 2.a and 2.b are images of a glazing comprising a stack comprising a layer liable to generate defects of hole type subjected to a heat treatment in a Naber furnace simulating a tempering with an annealing at 620° C. for 10 minutes. The substrate is according to the prior art, that is to say obtained according to a process not comprising the stage of heat pretreatment before deposition of the silver layer.

FIG. 1 shows black blemishes of dendritic form corresponding to the silver-free regions, that is to say to the defects of hole type obtained after tempering.

FIG. 2.a is an image in cross section taken with a transmission microscope of a defect of hole type. FIG. 2.b is an image taken with a scanning electron microscope which locates, by the white line, the cross section of FIG. 2.a. In this image, the glass substrate 1, the antireflective coating 2 comprising several dielectric layers which is located below the silver layer, the silver layer 3, the antireflective coating 4 located above the silver layer and a protective layer 5 are made out.

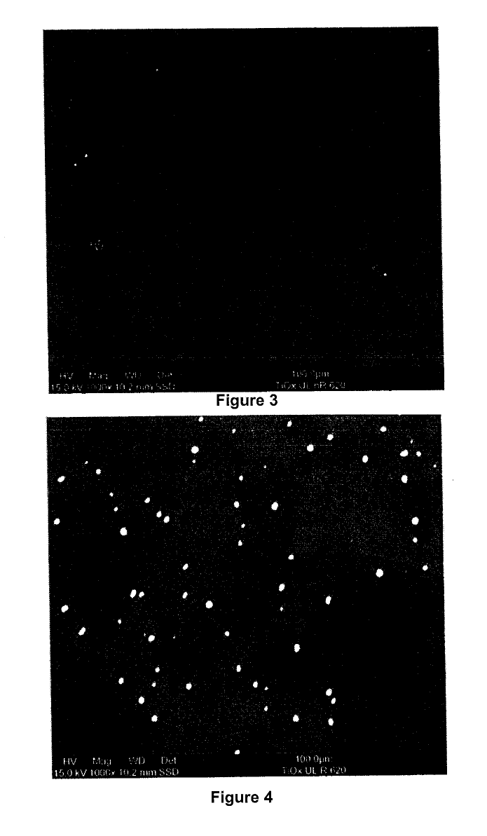

FIGS. 3 and 4 are images with a scanning electron microscope:
of a glazing comprising a stack D Comp. corresponding to a stack comprising a silver layer located above an antireflective coating comprising a non-pretreated layer of titanium oxide; the complete stack was subjected to a heat treatment at 620° C. for 10 min (FIG. 3),
of a glazing comprising a stack D Inv. corresponding to a stack comprising a silver layer located above an antireflective coating comprising a layer of titanium oxide pretreated before deposition of the silver layer; the complete stack was subjected to a heat treatment at 620° C. for 10 min (FIG. 4).

Numerous dendritic holes are observed in FIG. 3.

In FIG. 4, the absence of black blemishes shows the absence of defects of hole type. The few white blemishes correspond to defects of dome type. These defects do not correspond to a dewetting of the silver layer. It is noted that the amount of defects and thus the haze is reduced by virtue of the heat pretreatment according to the process of the invention.

The presence of defects after heat treatment can be quantified by measuring the proportion of surface area comprising defects on the heat-treated glazings. The measurement consists in determining the percentage of surface area occupied by the holes.

The images taken with an optical microscope of the different glazings and also the area occupied by said defects are summarized in the table below.

| FIG. | Glazing | Area of the defects |
|---|---|---|
| FIG. 3 | D Comp. | 8% of defects of hole type |
| | | 0% of defects of dome type |
| FIG. 4 | D Inv. | 1.3% of defects of hole type |
| | | 0.1% of defects of dome type |

The solution of the invention thus makes possible a significant decrease in the haze.

A marked decrease in the number of defects of hole type and thus in the haze is observed after high-temperature heat treatment.

1. A process for obtaining a material comprising a transparent substrate coated with a stack of thin layers comprising at least one silver-based functional metal layer located above at least one antireflective coating, the transparent substrate coated with the stack to be subjected to a heat treatment at a temperature Tmax of greater than 400° C., the antireflective coating comprising at least one dielectric layer configured to generate defects of hole type, the process comprising:
depositing the antireflective coating comprising at least one dielectric layer configured to generate defects of hole type on the transparent substrate, the dielectric layer configured to generate defects of hole type being deposited by cathode sputtering, then
subjecting the dielectric layer configured to generate defects of hole type to a heat pretreatment, then
depositing said at least one silver-based functional metal layer.

2. The process as claimed in claim 1, wherein the substrate is made of glass.

3. The process as claimed in claim 1, wherein the dielectric layer configured to generate defects of hole type is chosen from layers based on titanium oxide, on niobium oxide and on tin oxide.

4. The process as claimed in claim 1, wherein the stack comprises at least two antireflective coatings, each antireflective coating comprising at least one dielectric layer, so that each functional metal layer is positioned between two antireflective coatings; said process comprising depositing an antireflective coating above the silver-based functional metal layer.

5. The process as claimed in claim 1, wherein the substrate coated with the stack is subjected to a heat treatment at a temperature Tmax of greater than 450° C.

6. The process as claimed in claim 5, wherein the heat treatment is an annealing, a bending and/or a tempering.

7. The process as claimed in claim 1, wherein the heat pretreatment is carried out by contributing energy capable of bringing each point of the layer to a temperature of greater than or equal to 300° C.

8. The process as claimed in claim 7, wherein the heat pretreatment is carried out by contributing energy capable of bringing each point of the layer to a temperature of greater than or equal to 300° C. for a period of time of less than or equal to 1 second.

9. The process as claimed in claim 1, wherein the heat pretreatment is carried out using radiation, the wavelength of which is within a range extending from 500 to 2000 nm.

10. The process as claimed in claim 1, wherein the dielectric layer configured to generate defects of hole type has a thickness of greater than 5 nm.

11. The process as claimed in claim 1, wherein the dielectric layer configured to generate defects of hole type is separated from the functional layer by one or more layers; the thickness of all the layers inserted between the layer configured to generate defects of hole type and the functional layer is at most 20 nm.

12. The process as claimed in claim 1, wherein the dielectric layer configured to generate defects of hole type of the antireflective coating is separated from the functional layer by one or more layers; the thickness of all the layers inserted between the layer configured to generate defects of hole type and the functional layer is at least 6 nm.

13. The process as claimed in claim 1, wherein the dielectric layer configured to generate defects of hole type is chosen from a dielectric layer exhibiting a stress jump taking place within a temperature range lower than the temperature Tmax of the heat treatment and corresponding to a variation in the stress values of greater than 0.1 GPa for a variation in temperature of less than 50° C.

14. The process as claimed in claim 13, wherein the heat pretreatment is carried out by contributing energy capable of bringing each point of said layer to a temperature greater than or equal to a temperature located in the temperature range in which the stress jump takes place.

15. The process as claimed in claim 7, wherein the heat pretreatment is carried out by contributing energy capable of bringing each point of the layer to a temperature of greater than 400° C.

16. The process as claimed in claim 8, wherein the period of time is less than or equal to 0.5 second.

17. The process as claimed in claim 9, wherein the wavelength is within a range extending from 700 to 1100 nm.

18. The process as claimed in claim 17, wherein the wavelength is within a range extending from 800 to 1000 nm.

19. The process as claimed in claim 10, wherein the dielectric layer configured to generate defects of hole type has a thickness between 8 and 20 nm.

20. The process as claimed in claim 11, wherein the thickness of all the layers inserted between the layer configured to generate defects of hole type and the functional layer is at most 15 nm.
